(19) United States
(12) Patent Application Publication
(10) Pub. No.: US 2005/0192908 A1
(43) Pub. Date: Sep. 1, 2005

(54) Method of controlling electronic records

(75) Inventors: Urs Jorimann, Bertschikon (CH); Urs Wust, Greifensee (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mettler-Toledo GmbH

(21) Appl. No.: 10/786,540

(22) Filed: Feb. 26, 2004

(51) Int. Cl. G06F 17/60

(52) U.S. Cl. 705/67

(57) ABSTRACT

A method for controlling electronic records produced by an application software program for an analytical laboratory apparatus includes (a) restricting access to the application software program to designated users performing assigned user roles; (b) assigning a set of user rights to each user role; (c) storing the records in a protected data file format; (d) maintaining an audit trail of log-on's and activities performed in the application software program; and (e) authenticating the electronic records by means of at least one electronic signature. The designated users are divided into a first group who are given a right to sign the electronic records and a second group who are not given the right to sign electronic records, and access to step (e) is denied to users of the second group.

### BACKGROUND OF THE INVENTION

A method of controlling electronic records in laboratory and production environments, and a software program in which the method is implemented are disclosed. The electronic records can include for example data files containing analysis reports or test results generated by analytical instruments or analysis systems used for measuring and testing of material samples, particularly in pharmaceutical laboratories. More specifically, the electronic records can be those that are subject to the requirements of the U.S. Federal Food and Drug Administration (FDA) issued as Title 21, CFR Part 11—Electronic Records; Electronic Signatures.

An analytical instrument or system of the kind envisaged, for example a thermoanalyzer, is equipped to produce records in the form of electronic data files to document the activities performed on the apparatus, i.e., tests or measurements of samples, and also calibrations and program settings that may be made in the apparatus for example prior to a measurement series. To comply with government-mandated as well as internal quality- and safety-assurance requirements of laboratories and production facilities, such records are typically subject to a system of administrative controls to ensure their authenticity, integrity and reliability. Under a conventional system of records control, paper printouts are made of the electronic records, and each printed record is authenticated by one or more handwritten signatures. The paper records are archived and kept available, e.g., for reference and comparison purposes, to trace problems back to their sources, for audits, or for review by a regulatory agency such as the Food and Drug Administration.

With the current trend to produce, transmit and store records electronically and to eliminate all paper records, conventional methods of authenticating records through hand-written signatures need to be replaced by electronic methods of authenticating records and transactions.

Specific to the food and drug industry and its government-mandated laboratory and production records, the U.S. Food and Drug Administration (FDA) has issued the above-referenced regulations under 21 CFR. 11, which provide criteria for acceptance by the FDA, under certain circumstances, of electronic records and electronic signatures as equivalent to paper records and handwritten signatures executed on paper.

Electronic records can therefore replace paper records for FDA submission, for FDA inspection, and for archiving purposes. The purpose of the regulation is to ensure the integrity, trustworthiness and reliability of electronic records and, where used, electronic signatures.

The term “electronic record”, as defined in 21 CFR 11 and as used herein, means any combination of text, graphics, data, audio, pictorial or other information representation in digital form that is created, modified, maintained, archived, retrieved, or distributed by a computer system.

The regulation defines the term “electronic signature” as a computer data compilation of any symbol or series of symbols executed, adopted, or authorized by an individual to be the legally binding equivalent of the individual's handwritten signature.

The term “closed system”, which is fundamental to the present invention, is defined in 21 CFR 11 as an environment in which system access is controlled by persons who are responsible for the content of electronic records that are on the system.

A closed system with controlled access is described, e.g., in US 2002/0062449 A1, which is hereby incorporated by reference in its entirety. Software applications with a hierarchy of functions and sub-functions are made accessible selectively to different clients. The ability of the clients to utilize the various functions of the applications is controlled by an application security database system (ASDS). When a client requests access to one of the functions of the application software, the application program consults with the ASDS to determine whether the client is authorized to perform the requested function. Based on the response from the ASDS, the application program performs or declines to perform the requested function. Examples of preferred embodiments in US 2002/0062449 A1 relate to the field of securities trading. In general terms, the concepts are said to be applicable to other environments where access to different functions of a software program is to be controlled. However, at least the specific aspects of authenticating records through electronic signatures as required by 21 CFR 11 are not covered.

A state-of-the-art concept for a closed system related specifically to laboratory applications is described for example in WO 02/14809, which is hereby incorporated by reference in its entirety. An analytical laboratory apparatus such as an analytical balance is equipped to store sets of parameter values (so-called profiles) that correlate on the one hand to specific measurement tasks to be performed on the apparatus and on the other hand to specific persons who are performing the tasks on the apparatus. The apparatus according to WO 02/14809 has the capability to recognize individual users whose user profiles are stored in the apparatus and to activate a stored task parameter profile associated with a recognized user. The recognition of the user is based on specific communications or signals exchanged between the user and the apparatus, e.g., transponder badge signals, bar code signals, voice signals, optical recognition of certain user traits, as well as conventional passwords entered through a keyboard.

A system of the foregoing kind provides a significant level of security that the records produced by the analytical apparatus are trustworthy, because the activities and results stated on the record had to be performed by an authorized person (whose name can also be stated on the record). However, the record does not indicate whether the data are firm and final and whether the person who performed the measurements and/or other authorized persons who reviewed the data are taking responsibility for them and are agreeing to the release of the data.

### SUMMARY OF THE INVENTION

A method of controlling electronic records in a manner that meets or exceeds the requirements of 21 CFR 11 is disclosed. Specifically, the method includes steps to authenticate the records by attaching electronic signatures of a plurality of individuals who have different hierarchical levels of responsibility and authority relative to the records being signed.

A method of records control is disclosed that is implemented in an application software system for an analytical laboratory apparatus which is used by a defined group of designated users who perform defined user roles and are given individual user accounts for the application software. The method can be configured so that it fully conforms to a set of requirements issued by the U.S. Federal Food and Drug Administration (FDA) and known as “Title 21, CFR Part 11 —Electronic Records; Electronic Signatures”. The method encompasses at least the following principal steps:
(a) controlling access to the application software through a user authentication, for example by requiring users to identify themselves with a user name and a password;
(b) assigning a set of user rights to each user role (the term “user role” may be synonymous with a user's job function such as technician or scientist);
(c) protecting the integrity of the data files containing the electronic records;
(d) maintaining a history of access entries and activities performed in the application software; and
(e) authenticating the electronic records by means of at least one electronic signature of a user of the application software.

Specifically, the set of user rights assigned to a user role in step b either includes or excludes the right to sign an electronic record. Basically, the method separates the users of the application software into a first group of users who have the right to sign records and a second group of users who do not have the right to sign records. The second group may consist, e.g., of users who have access to the application software and are allowed to review but not to sign records.

The step of signing an electronic record (i.e., step e) can be subject to a separate access control by means of an additional authentication, for example by again requiring the user to enter his/her user name and password.

In a further developed embodiment, an electronic record can be authenticated by more than one signature. Each signature is qualified by a specific meaning selected from an administrator-defined hierarchical list, which typically includes (but is not necessarily limited to) the terms “Tested” (indicating that the signer performed the experiment or test that is documented in the record), “Reviewed”, “Approved”, “Released”. In other words, the meaning that is attached to a signature under the method defines the status that the record will have as a result of the respective signature. The hierarchical ranking of each signature meaning is defined by a number, for example from 1 to 4, which is referred to as the signature level. Thus, the aforementioned meanings “Tested”, “Reviewed”, “Approved”, “Released” would correlate to signature levels 1 to 4, respectively.

As a further part of the concept of hierarchically ranked signatures, each user who has the basic right to sign records (i.e., each user of the first group) is assigned a maximum signature level, i.e., the highest-ranking meaning that can be attached to his/her signature. For example, in the aforementioned four-level system, if a user's maximum signature level is 2, he would only be allowed to attach the meanings “Tested” or “Reviewed” to his signature.

It should be noted that while the signature meanings/levels are hierarchically ranked, the maximum signature level assigned to an individual does not necessarily correlate to that individual's organizational ranking. For example, a system administrator may have the rights to assign user rights to user roles and to define signature meanings/levels without having the right to create and sign analysis records, or without having the right to assign roles to individuals. A laboratory manager, on the other hand, may be given a maximum signature level of 10 as well as the right to assign roles and signature levels to employees reporting to him, but he may not have the rights to configure the system which are reserved for the administrator.

In a more restricted version, the assigned maximum signature levels may be automatically tied to a user's job function and/or organizational level.

An exemplary embodiment includes the additional rule that a signer can select only a signature meaning that ranks at least at the same level as the current status of the record. Under this rule, if a user whose maximum signature level is 3 signs a record that carries previous signatures with a highest-ranking meaning of “Reviewed” (level 2), he or she could attach either of the meanings “Reviewed” or “Approved” (i.e., at least level 2 but no higher than level 3) to his/her own signature.

Under a more restrictive rule, a signer can select only a signature meaning that ranks at least one level higher than the current status of the record. In this case, if a user whose maximum signature level is 3 signs a record that is at the “Reviewed” status, the only meaning that can be attached to his/her signature is “Approved” (higher than level 2, but at the same time no higher than level 3).

Under an even further restricted rule, the only meaning that a signer can attach to his/her signature is the next-higher meaning in the hierarchical list, so that the signatures attached to the record follow each other in consecutive ascending order of signature level.

The three preceding embodiments can be considered examples of a general concept, whereby the choice of meanings that a user can attach to his/her own signature is subject to two limitations: On the one hand, the meaning cannot exceed the user's maximum signature level, and on the other hand, the meaning is subject to a limitation dictated by the current signature status of the record.

Under another embodiment, a record is fully authenticated if it carries a prescribed number of signatures with at least two different signature levels.

A more restrictive rule could be incorporated, where a record is fully authenticated after a prescribed number of signatures with a prescribed ascending series of meanings have been attached to the record. For example, one could set the rule that three signatures with the meanings “Tested”, “Reviewed”, “Released” are required for authentication of a record.

In an exemplary embodiment, the system has a reserve capacity for a larger number of signature levels than will normally be used. For example, a system may be prepared for signature levels from 1 to 10. If only the four signature meanings “Tested”, “Reviewed”, “Approved” and “Released” have been defined, they could be assigned, e.g., to the levels 2, 4, 7 and 9 respectively, leaving the levels 1, 3, 5, 6, 8 and 10 available for additional meanings that may be defined in the future.

As a practical aspect of the method and its various embodiments, certain steps and substeps can be performed by a system administrator, including for example:
opening user accounts, i.e., assigning user names and passwords to users,
maintaining user accounts, e.g., periodically changing passwords,
closing user accounts, i.e., retiring user names and passwords,
defining the signature meanings and assigning them to numerical signature levels, subject to a limit that is built into the application software,
assigning a maximum signature level to each user account,
managing system security, e.g., setting the maximum number of failed log-in attempts before an account is locked out.

As mentioned at the beginning, the method is advantageously implemented in an application software program. An exemplary embodiment of the program includes a signing procedure for authenticating the electronic records with a plurality of electronic signatures, with the following steps:
(a) the users of the program are separated into a first group who are given the right to sign the electronic records and a second group who are denied the right to sign the records;
(b) access to the signing procedure is restricted to the users of the first group through a verification routine where the user has to legitimize himself, e.g., by entering a user name and password;
(c) each signer attaches to his/her own signature a signature meaning selected from a list in which signature meanings are ranked according to signature levels defined as ordinal numbers;
(d) each user of the first group is assigned a maximum signature level; and
(e) the signing procedure is controlled in such a way that the user can sign a record only with a signature meaning that ranks at least as high as any previous signature attached to the record, but not higher than the user's maximum signature level.

In an advantageous variation of step (e) in the foregoing software concept, the signing procedure is controlled in such a way that the user can sign a record only with a signature meaning that ranks at least one level higher than any previous signature attached to the record, but again not higher than the user's maximum signature level.

### BRIEF DESCRIPTION OF THE DRAWINGS

The following detailed description of a preferred embodiment refers to the attached drawings, wherein:

FIG. 1 shows a conventional “log-in” box that presents itself to the user when logging on to the application software associated with an exemplary method disclosed herein;

FIG. 2 shows an exemplary data entry box in which the system administrator sets the parameters of a password control associated with the method;

FIG. 3 shows an exemplary data entry box in which the system administrator assigns a set of rights to a user role;

FIG. 4 shows an exemplary data entry box in which the system administrator creates and/or changes a user account;

FIG. 5 represents an exemplary excerpt of the system audit trail;

FIG. 6 represents an exemplary excerpt of the analysis audit trail;

FIG. 7 shows a second “log-in” box that presents itself to a user when entering the step of attaching an electronic signature to a record;

FIG. 8 illustrates a signed record;

FIG. 9 illustrates an exemplary manner in which the electronic signatures present themselves to a viewer of the record;

FIG. 10 illustrates an entry mask in which signature meanings are named and ranked according to numerical signature levels;

FIG. 11a represents an exemplary flowchart of the configuration part; and

FIG. 11b represents an exemplary flowchart of the signing procedure.

### DETAILED DESCRIPTION OF PREFERRED EMBODIMENT

The following description of preferred embodiments is based on a company publication entitled “21CFR 11 Compliance”, published on the Internet by Mettler-Toledo, the assignee of the present invention.

An exemplary embodiment includes the substantially conventional steps of (a) controlling access through user names and passwords; (b) assigning different access rights to different user roles; (c) protecting the integrity of the data files containing electronic records; and (d) maintaining a history of access entries and activities performed in the application software. In combination with the foregoing steps (a) through (d), the invention proposes innovative procedures under a step (e) for authenticating the electronic records by means of one or more electronic signatures.

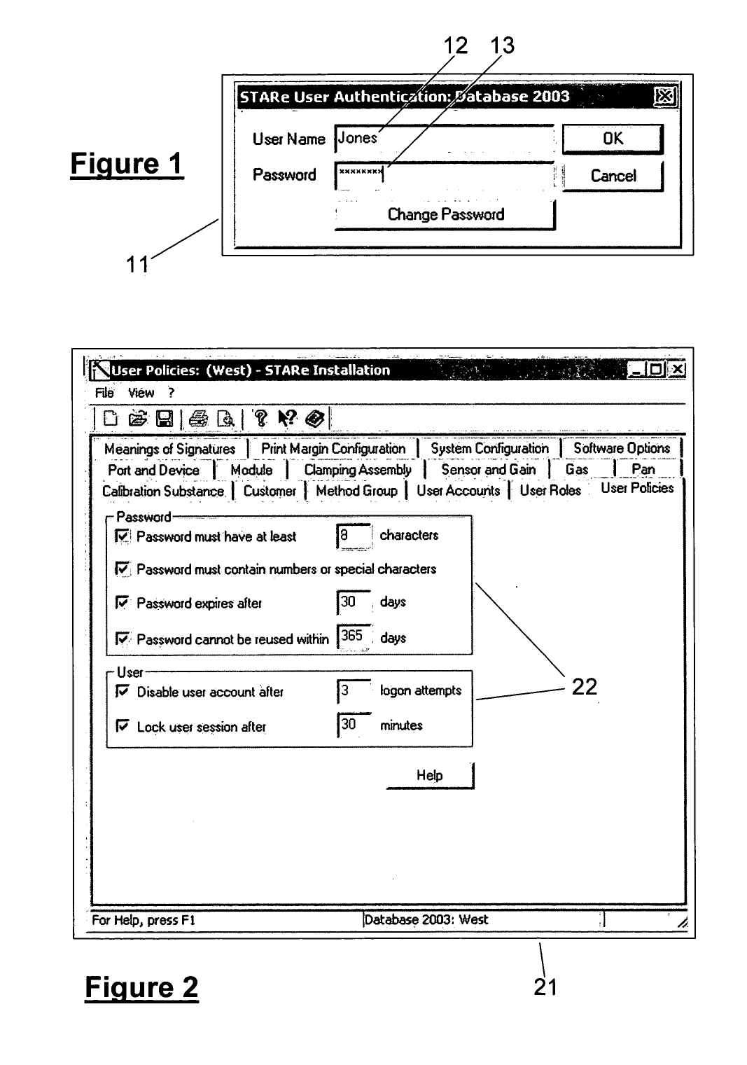

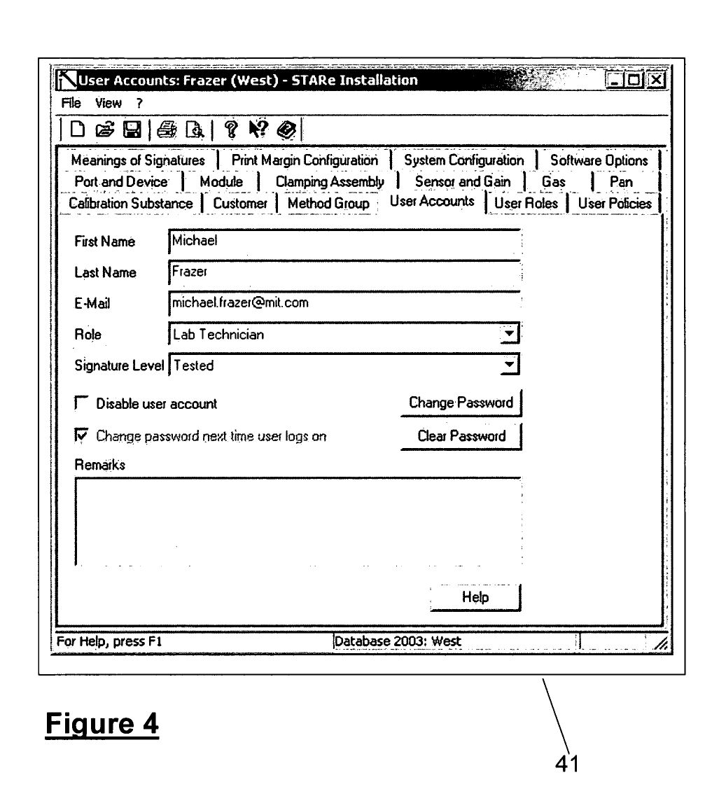

FIGS. 1 to 4 illustrate steps (a), access control, and (b), assigning access rights. To be allowed access to the application software, a user must have a user account which has been established by the system administrator by completing the entry form 41 of FIG. 4. To log on to the program, a user must legitimize himself by entering a user name 12 and a password 13 in a log-in box 11 presented on a computer screen (FIG. 1). Each authorized individual has a unique user name and password that are subject to user policies set by a system administrator of the application software. An example of an entry box 21 for user policies 22 is shown in FIG. 2.

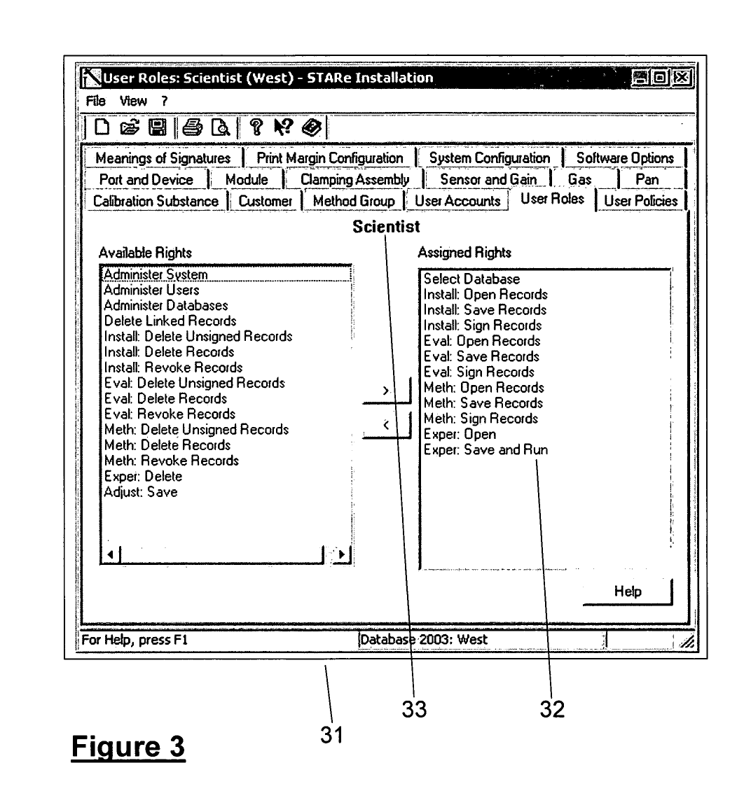

Under step (b) specific user rights are assigned to each user. In practice, this means that access rights to different functions of the software are assigned according to user roles. Examples of user roles are administrator, lab manager, scientist, laboratory technician, operator. A role-specific set of rights is associated with each user role. A set of rights available to an authorized laboratory technician can include, e.g., the right to open a blank record, run an experiment, save the record, and sign the record, while it could, e.g., exclude the rights to change, revoke, or delete a record. An authorized chief scientist could be given the right to release an approved record for company-internal distribution, and an authorized officer of the company could be given the right to release an appropriately approved record for release to the FDA or other appropriate external parties. As an example, FIG. 3 shows a completed entry box 31 in which the user rights 32 are defined for the user role 33 of a scientist.

Step (c)—protecting the integrity of electronic records—is implemented by storing the records in a relational INGRES (INteractive Graphics and REtrieval System) database to protect the records against intentional or accidental modification or deletion. As a result, the database containing the electronic records cannot be accessed from the Windows® operating system of the computer.

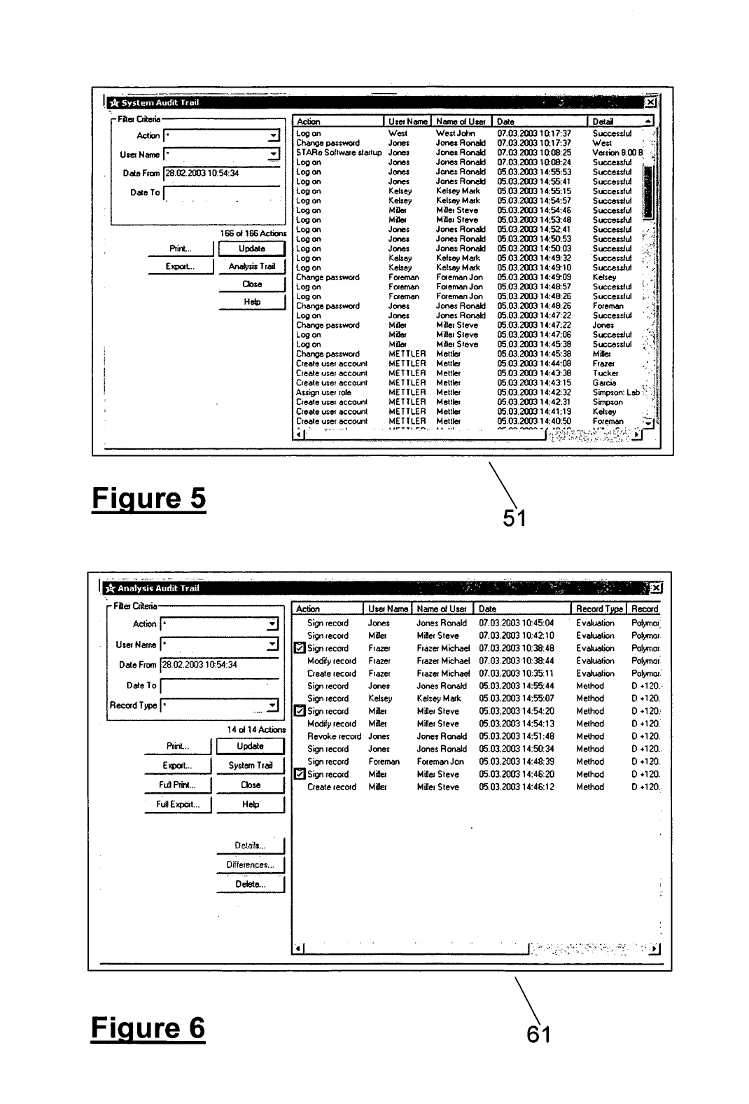

Step (d)—maintaining a history of access entries and activities—is implemented in the form of an audit trail facility in the inventive applications software. The audit trail facility has two parts:
(1) A system audit trail 51 (see FIG. 5) that keeps track of all log-on's, system changes such as software version updates, creation and retirement of user accounts; and
(2) an analysis audit trail 61 (see FIG. 6) that keeps track of the detailed work activities performed on the analytical apparatus and documented in electronic records, e.g., creation, modification, review, signature, deletion of each electronic record with time, date and user name.

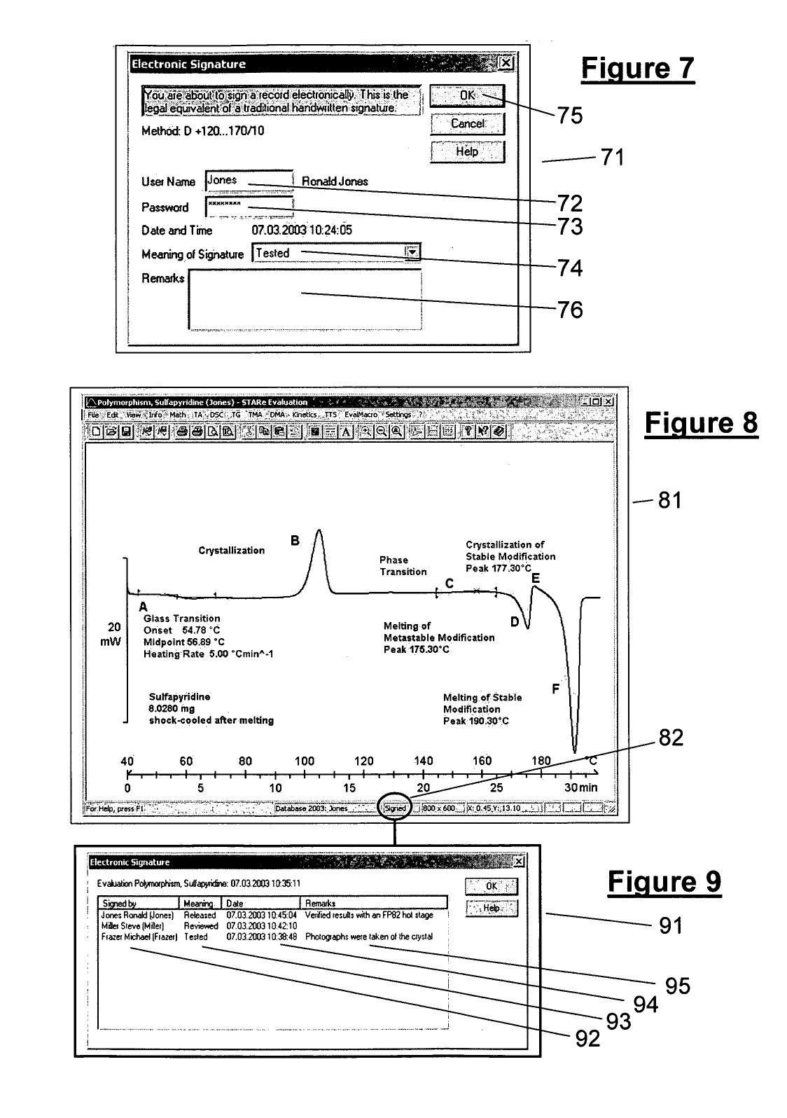

FIGS. 7 to 9 illustrate step (e) of an exemplary method: authenticating an electronic record by means of at least one electronic signature of a user of the application software. When a user decides to sign an electronic record, he legitimizes himself by entering his user name 72 and password 73 in an entry box 71 on a computer screen (see FIG. 7). The entry box 71 includes a drop-down field 74 “Meaning of Signature” in which a list of signature meanings is presented to the user for selection. After the user has selected the meaning to be attached to his/her signature, the program determines whether the selected meaning is compatible with that user's maximum signature level and also whether the selected meaning is compatible with other rules built into the program.

According to an embodiment that has been mentioned previously, the signature rules may require a meaning that ranks, e.g., at least one level higher than the level of the highest signature attached to the record up to this point. Thus, a meaning that the program will allow a user to attach to his/her signature can be one or more levels higher than the highest meaning of any previous signature of the same record, as long as it does not exceed the user's maximum signature level. As an optional step, the user may enter a remark in the “Remarks” field 76. The electronic signature is completed and becomes effective by clicking on the “OK” button in the display box 75.

FIG. 8 displays a record 81 of a calorimetric analysis. The word “signed” in the signature status field 82 at the bottom of the display window indicates that at least one signature is attached to the record. A viewer of the record can check the signature status, e.g., by clicking on the signature status field 82. As a result, the window box 91 “Electronic Signature” (FIG. 9) appears on the computer screen, showing the electronic signatures 92 in descending order of signature level, with their respective meanings 93, dates 94, as well as any remarks 95 added by the signers.

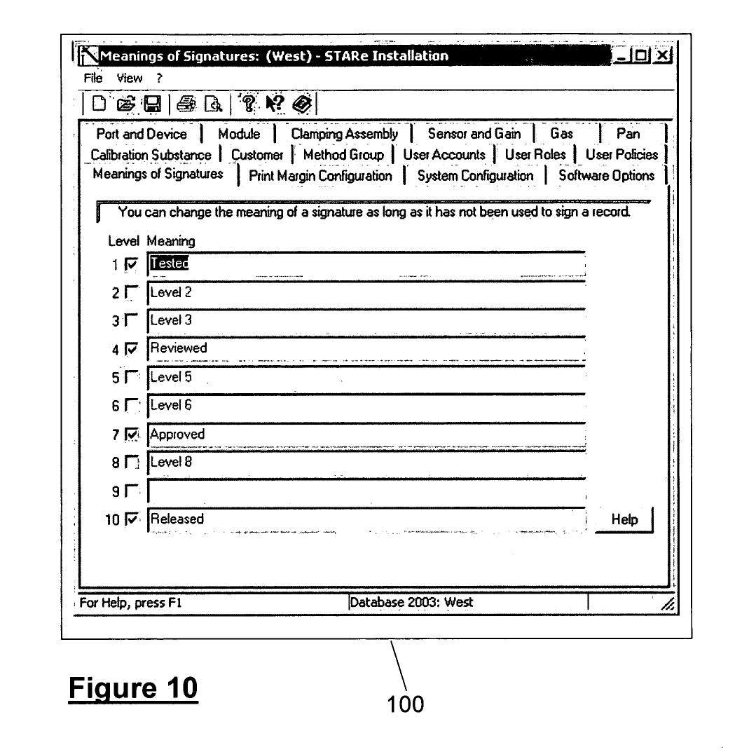

FIG. 10 represents an entry mask 100 that is displayed on the computer screen for the system administrator to name the signature meanings and rank them according to numerical signature levels. The illustrated entry mask 100, which belongs to an exemplary embodiment, allows up to 10 signature meanings to be defined and ranked in a hierarchy of 10 levels. In the specific example shown in FIG. 10, only four meanings, i.e., “Tested”, “Reviewed”, “Approved”, and “Released” have been defined and assigned to the levels 1, 4, 7 and 10, respectively. The unused levels 2, 3, 5, 6, 8 and 9 remain available for future use, so that additional signature meanings can be defined and ranked between the currently used four levels.

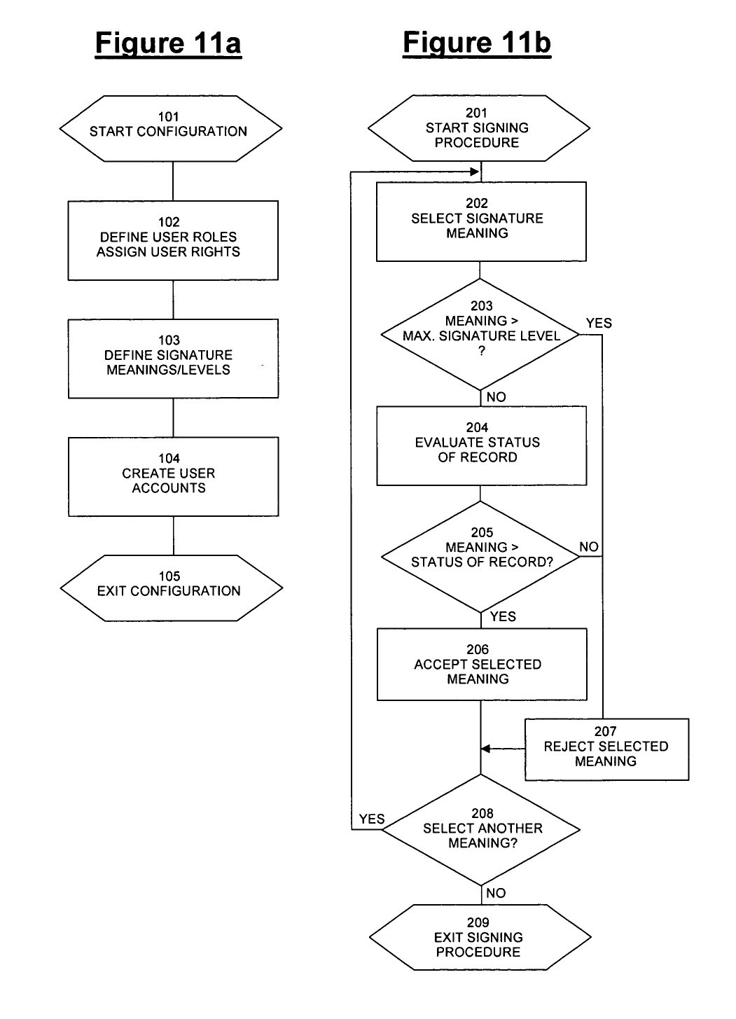

The flowchart of FIG. 11a illustrates the process in which the system administrator configures the software program that embodies an exemplary method of controlling electronic records. After entering his/her username and password, the system administrator is recognized by the program and allowed access to the configuration part of the software (Step 101). The configuration part includes several entry masks that are displayed on the computer screen for the administrator to enter information and/or to select from available options. In the example of a configuration process shown in FIG. 11a, the system administrator completes the steps of:
(102) defining user roles and assigning a specific set of user rights to each user role,
(103) defining the signature meanings and ranking each meaning according to a hierarchy of signature levels,
(104) establishing user accounts for the individuals that are authorized to use the program and assigning a user role and a maximum signature level to each user account.

After the system administrator has exited the program (step 105), the configuration part is locked against access by anyone who does not have the right to enter the configuration part.

The flowchart of FIG. 11b illustrates the process in which a user signs an electronic record under the software program that embodies the inventive method. After entering his/her username and password, the user is recognized by the program and allowed access to the electronic signature part of the software (Step 201). The signature part has a sequence of steps that may require a response by the user or are performed automatically by the program. The electronic signing process that is shown as an example in FIG. 11b has the following steps:
(202) The user indicates the signature meaning to be attached to his/her signature by selecting one of the signature meanings available in a drop-down field of a screen entry box (see for example FIG. 7).
(203) The program checks whether the selected signature meaning ranks higher than the maximum signature level allowed for this user. In the affirmative case, the program proceeds to step 207 and in the negative case to step 204.
(204) The program evaluates the current signature status of the record, i.e., the program determines the highest level of any signature previously attached to the same record.
(205) The program verifies if the signature meaning selected by the current user is higher than the signature status found in the preceding step 204. In the affirmative case, the program advances to step 206 and in the negative case to 207.
(206) The program accepts the selected meaning and proceeds to step 208.
(207) The program rejects the selected meaning and likewise proceeds to step 208.
(208) If the user selects another signature meaning, the program loops back to step 202. If the signature meaning is left unchanged and the user terminates the electronic signature routine by clicking “OK”, the signing procedure ends at step 209, and the electronic signature part is locked again.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method for controlling electronic records produced by an application software program for an analytical laboratory apparatus, wherein the program and apparatus are used by designated users performing assigned user roles, said method comprising:
(a) restricting access to the application software program to the designated users through a user authentication;
(b) assigning a set of user rights to each user role, wherein said designated users are divided into a first group of users who are given a right to sign the electronic records and a second group who are denied the right to sign the electronic records;
(c) storing the electronic records in a protected data file format;
(d) maintaining a history of access entries and activities performed in the application software program; and
(e) authenticating the electronic records by means of at least one electronic signature by one of the users of the first group, wherein access to step (e) of the method is denied to users of the second group.

2. The method of claim 1, wherein the method conforms to a set of requirements issued by the U.S. Federal Food and Drug Administration (FDA) and known as “Title 21, CFR Part 11—Electronic Records; Electronic Signatures”.

3. The method of claim 1, wherein access to step (e) is subject to an additional user authentication.

4. The method of claim 1, wherein the at least one electronic signature comprises a plurality of electronic signatures, wherein a signature meaning is attached to each of said plurality of electronic signatures, said signature meaning being selected from a list of signature meanings, wherein the signature meaning indicates a signature status that an electronic record will have as a result of an electronic signature, and wherein each signature meaning in said list is correlated with a signature level in a hierarchy ascending from a lowest to a highest signature level, so that each of said plurality of electronic signatures is hierarchically ranked by way of its attached meaning.

5. The method of claim 4, wherein the hierarchically ranked meanings include at least one of the meanings “Tested”, “Reviewed”, “Approved”, and “Released”.

6. The method of claim 4, wherein each user of the first group is assigned a maximum signature level that is selected from the signature levels in said list, and wherein said user is not allowed to attach to his/her signature a signature meaning that exceeds said user's assigned maximum signature level.

7. The method of claim 6, wherein said maximum signature level is assigned to a user in accordance with the user role performed by said user.

8. The method of claim 6, wherein when the electronic record has already been signed at least once, said user is not allowed to attach to his/her signature a signature meaning that ranks lower than the signature status which the electronic record has as a result of said at least one previous signature.

9. The method of claim 6, wherein when the electronic record has already been signed at least once, said user is not allowed to attach to his/her signature a signature meaning that does not rank at least one level higher than the signature status which the electronic record has as a result of said at least one previous signature.

10. The method of claim 6, wherein said user is only allowed to attach to his/her signature a signature meaning exactly one level higher than the signature status which the electronic record has as a result of said at least one previous signature, so that said plurality of signatures follow each other in consecutive ascending order of signature level.

11. The method of claim 4, wherein a record is fully authenticated after a prescribed number of signatures comprising at least two different signature levels have been attached to said record.

12. The method of claim 11, wherein the at least two different signature levels comprise a prescribed hierarchically ascending series of signature levels.

13. The method of claim 1, wherein step (e) comprises attaching a remark to the electronic signature.

14. The method of claim 4, wherein the signature levels attached to the signature meanings in said list from the lowest to the highest level are consecutive ascending numbers starting at the number one.

15. The method of claim 4, wherein the signature levels attached to the signature meanings in said list from the lowest to the highest level are non-consecutive ascending numbers, leaving unused numbers available for additional intermediate signature levels.

16. The method of claim 6, wherein parts (a) and (b) of the method are performed by a system administrator.

17. The method of claim 16, wherein said parts (a) and (b) include at least one of:
assigning user names and passwords to the designated users,
retiring said user names and passwords,
assigning the maximum signature level to each user account, and
defining the signature meanings and ranking them according to signature levels.

18. An application software program that implements a method for controlling electronic records in an analytical laboratory apparatus, wherein the method comprises a signing procedure for authenticating the electronic records with a plurality of electronic signatures, with the following steps:
(a) designating a first group of users who are given a right to sign the electronic records and a second group of users who are denied the right to sign the electronic records;
(b) restricting access to the signing procedure to the users of the first group through a verification routine in said application software program;
(c) establishing a list of signature meanings to be attached to the electronic signatures, wherein each signature meaning in said list is ranked according to a signature level defined as an ordinal number;
(d) assigning to each user of the first group a maximum signature level; and
(e) controlling said signing procedure so that the user can sign a record only with a signature meaning that ranks not lower than any previous signature attached to the record and not higher than the user's maximum signature level.

19. The application software program of claim 18, wherein step (e) comprises controlling said signing procedure so that the user can sign a record only with a signature meaning that ranks higher than any previous signature attached to the record, but not higher than the user's maximum signature level.
